(19) United States
(12) Patent Application Publication
(10) Pub. No.: US 2023/0305541 A1
(43) Pub. Date: Sep. 28, 2023

(54) Method and System for Automatically Characterizing a Workpiece During a Machining Process Using a Machine Tool

(71) Applicant: ZF Friedrichshafen AG, Friedrichshafen (DE)

(72) Inventor: Jan Glitza, Kirkel (DE)

(21) Appl. No.: 17/794,638

(22) PCT Filed: Jan. 21, 2021
(86) PCT No.: PCT/EP2021/051272

§ 371 Date: Jul. 22, 2022

(30) Foreign Application Priority Data
Jan. 23, 2020 (DE) 10 2020 200 772.1
Dec. 18, 2020 (DE) 10 2020 216 272.7

(51) Int. Cl. G05B 19/418

(52) U.S. Cl. CPC G05B 19/41875; G05B 2219/37439

(57) ABSTRACT

A method for automated characterization of a workpiece (21) during a machining operation by a machine tool (22, 23, 1) includes acquiring a data set describing the machining operation, selecting and extracting the workpiece (21) from a plurality of workpieces (21) in accordance with an algorithm, and linking the data set to the workpiece (21) via an assignment. The method also includes selecting a subsequent process from a plurality of possible subsequent processes (6, 6′ in an automated manner via the data set.

### CROSS-REFERENCE TO RELATED APPLICATION

The present application is related and claims priority to 102020200772.1 filed in the German Patent Office on Jan. 23, 2020 and to 102020216272.7 filed in the German Patent Office on Dec. 18, 2020 and is also a U.S. national phase of PCT/EP2021/051272 filed in the European Patent Office on Jan. 21, 2021, all of which are incorporated by reference in their entirety for all purposes.

### FIELD OF THE INVENTION

The present invention relates generally to a method for the automated characterization of a workpiece during a machining operation by a machine tool and to a system for the automated characterization of a workpiece during a machining operation by a machine tool.

### BACKGROUND

Machine data is acquired and stored during the manufacture or machining of a workpiece by a machine. Moreover, it is known to extract a number of workpieces from a quantity of workpieces, which have been manufactured or machined by one and the same machine, and measure these workpieces with respect to quality and/or properties in a random manner or in accordance with an algorithm. Inferences can then be made regarding the quality and the properties of the remaining workpieces on the basis of the machine data, on the one hand, as well as on the quality and the properties of the extracted workpieces, on the other hand. Finally, data matrix codes are also known, which can be applied directly on a product or workpiece and can describe predefined information.

In this context, DE 10 2015 004 227 A1 describes a method for introducing a three-dimensional coding into a workpiece to be produced with a tool. The coding is characteristic of at least one property of the workpiece and is introduced into the workpiece by a data matrix during the manufacturing.

The known methods have disadvantages, however, in that the possibilities resulting from this type of identification of the workpieces have not yet been fully exploited.

### SUMMARY OF THE INVENTION

Example aspects of the invention provide an improved method for the automated characterization of a workpiece during a machining operation by a machine tool.

Example aspects of the invention provide a method for the automated characterization of a workpiece during a machining operation by a machine tool, wherein a data set describing the machining operation is acquired, wherein the workpiece is selected from a plurality of workpieces in accordance with an algorithm and is extracted, and wherein a link of the data set to the workpiece is carried out via an assignment. The method according to example aspects of the invention is distinguished by a selection of a subsequent process from a plurality of possible subsequent processes carried out in an automated manner via the data set.

Example aspects of the invention therefore describe a method, which permits a fully automated characterization of a workpiece during a machining operation by a machine tool. The machine tool is preferably a machine tool that is assigned to a production line having a plurality of further machine tools. Advantageously, the production line can also include different inspection machines, which inspect the workpiece after certain machining operations. The workpiece generally passes through all machine tools with the particular machining operations as well as all inspection machines with the particular inspection processes of the production line in a predefined sequence.

A “characterization” within the meaning of the invention is understood to be a detection and an assignment of workpiece-specific properties to the particular workpiece. The workpiece-specific properties are, for example, a force or torque applied by the machine tool, a temperature during the machining by the machine tool, a time duration of the machining by the machine tool, or also a shaping, to which the workpiece is subjected during the machining by the machine tool. These properties can differ for different workpieces such that some workpieces have a higher quality than others and/or must be reworked or represent non-reworkable rejects, such as NOK parts (Not Okay parts), and are combined in a data set. Since these properties are substantially characterized by the machining carried out by the machine tool, the properties can therefore also be detected by the machine tool. For this purpose, the machine tool preferably includes the particular necessary sensors such as, for example, a temperature sensor, a timer, a current sensor, a force or torque sensor, as well as an electronic memory or at least one electronic data interface for transmitting the data set to a database having an electronic memory.

A “production line” is understood, within the meaning of the invention, to be a group of machine tools that subject a workpiece to different machining processes—which build upon each other—successively in a predefined sequence. For example, a production line can be made up of a stamping machine, a shaping machine, and a grinding machine, wherein a workpiece is punched out of a steel sheet by the stamping machine in a first machining operation, the punched-out workpiece is shaped by the shaping machine in a second machining operation, and the shaped workpiece is ground by the grinding machine in a third machining operation.

The workpiece is preferably a metallic workpiece, in particular a gearwheel or a shaft, which is intended for installation into a complex assembly. The complex assembly is, in particular, a transmission for a motor vehicle.

In addition, an algorithm is executed, which is executed in the form of a computer program product by an electronic control unit of the machine tool or by a separate control unit designed therefor. The algorithm specifies which workpieces are selected by the machine tool immediately after machining of the workpieces. The workpieces selected in this way are then extracted from the machine tool, in order, for example, to pass through a series of tests and inspections, which, in particular, go beyond the tests and inspections carried out by default on all workpieces. These tests and inspections advantageously function as the quality control of the workpiece. Due to the fact that the selected workpieces are extracted from the machine tool, the workpieces are, in particular, not automatically forwarded to the next station of the production line, i.e., to the next machine tool or to the next inspection machine.

During the extraction, the workpiece-specific properties are then assigned to the workpiece in the form of the data set, so that, for example, a human operator or also a computer can inspect and/or read out the properties of the workpiece contained in the data set and, therefore, obtain information regarding the individual workpiece. It is important that the assignment of the data set to the workpiece be reliably and correctly carried out, i.e., that the data set assigned to each extracted workpiece is, reliably exclusively, the data set that also actually describes this workpiece.

A selection of a subsequent process from a plurality of possible subsequent processes is then carried out, according to example aspects of the invention, in an automated manner via the data set. The subsequent process can be, for example, an inspection of one specific property or multiple specific properties of the workpiece, for example, a geometric shape, an electrical conductivity, or a material hardness. The subsequent process can also be a logistics process, however. For example, the extracted workpiece can be brought to another location, for example, in order to store the extracted workpiece there for subsequent inspections or as a spare part. Similarly, the subsequent process can be, for example, a disposal of the workpiece. The subsequent process is not a process that is carried out by default on all workpieces and, in particular, is not carried out by a machine tool or an inspection machine on the production line.

This yields the advantage that a considerable improvement of the quality assurance is enabled via the data set assigned to the workpiece and the subsequent action selected and carried out in an automated manner in accordance with the data set. This enables, in turn, improved transparency and a deeper understanding of the production processes in detail as well as of their interacting influences. The influence of certain deviations in a production process on the expected quality of the workpiece can also be significantly improved.

It is not necessary, in particular, according to example aspects of the invention, that every single workpiece machined by a machine tool is subjected to the method according to example aspects of the invention. Rather, individual workpieces can be selected at random and/or according to a stochastic selection method, which are subjected to the method according to example aspects of the invention. The workpieces selected in this way can also be handled representatively for the production lot associated therewith, i.e., such that a subsequent process selected for the selected workpiece on the basis of its associated data set is selected for every single workpiece of the production lot that is represented by the one selected workpiece.

Regardless of whether every single workpiece machined by a machine tool is subjected to the method according to example aspects of the invention, an assignment can nevertheless be generated for every single workpiece without creating the associated data set, however. In this case, the assignment permits a traceability of the workpieces independently of the method according to example aspects of the invention.

According to one preferred example embodiment of the invention, it is provided that the assignment includes at least one further link to at least one further data set. Due to the fact that one further data set, i.e., further workpiece-specific properties, is/are acquired or detected and assigned to the workpiece, a further improved transparency of the individual production processes as well as of the interrelationships between the different production processes as well as between the production processes and the quality of the workpieces results. In addition, different data sets can therefore also be particularly easily linked to one another via their assignment to the workpiece. Examples of these types of data sets can be, for example, machine data sets, material data sets, parts data sets, process data sets, technology data sets, quality data sets, monitoring data sets, or logistics data sets.

According to a further preferred example embodiment of the invention, it is provided that the assignment is carried out by arranging the data set and/or the at least one further data set directly on the workpiece. As a result, it is ensured that the assignment of the data set or of the at least one further data set to the workpiece cannot become lost or mixed up. The data set or the at least one further data set can be permanently arranged on the workpiece or detachably arranged on the workpiece.

Preferably, it is provided that the assignment is designed to be machine-readable, i.e., for example, can be detected by a camera or a laser scanner and read out and processed by a downstream evaluation logic.

According to one particularly preferred example embodiment of the invention, it is provided that the data set and/or the at least one further data set can be arranged, as a data matrix code or as a label, on the workpiece. The data matrix code can be permanently arranged on the workpiece, for example, by embossing styluses or by a laser. Provided that further data sets are assigned to the workpiece, the data matrix code can be expanded or an additional data matrix code can be arranged on the workpiece. The label, however, is generally detachably arranged on the workpiece. If further data sets are assigned to the workpiece, the label can be removed and replaced by a new label, or the new label can simply be placed over the original label. It is also conceivable, of course, to apply multiple labels next to one another. The label or the labels can have, for example, a barcode. The data matrix code as well as the barcode immediately represent all information of the data set.

According to a further preferred example embodiment of the invention, it is provided that the data set and/or the at least one further data set are/is stored in a database and the assignment is carried out by arranging a piece of information referring to the data set and/or to the at least one further data set on the workpiece. The piece of information referring to the data set and/or to the at least one further data set is a “unique identifier.” In this case, the information of the data set is not arranged directly on the workpiece, but rather only a piece of information that refers to the data set and, if necessary, further data sets. The piece of information that refers to the data set and, if necessary, to further data sets, can be, for example, an address of an entry in an electronic database, where all information of the data set and, if necessary, further data sets, is stored. A simple example of this type of database is, for example, an email mailbox, to which the individual data sets are sent as emails. For this purpose, the emails advantageously have preformatted content, which enables machine-readability. A subject line of the email can then establish, for example, via a number, the assignment to the workpiece, which is therefore characterized with the same number. In this case, the number on the workpiece therefore represents the piece of information referring to the data set or to the at least one further data set. The number can be, for example, a serial number, which the workpiece receives from a corresponding machine tool. The serial number can be provided, in particular, by a total-parts counter of the machine tool. One further example of a comparatively simple implementation of a database according to this preferred example embodiment of the invention is, for example, a spreadsheet software, which can record different data sets from different machine tools in different columns. A row in the spreadsheet software having a plurality of columns can then be assigned to the workpiece, for example, via the unique identifier.

According to a further preferred example embodiment of the invention, it is provided that the algorithm represents a statistical method for selecting random samples. The algorithm can be, in particular, a SPC algorithm (SPC=Statistical Process Control). The workpiece selected in this way then acts as a representative member of the entire production lot of workpieces from which the representative member originates, i.e., the entire production lot can be represented by the workpiece selected in this way and, thus, also assessed with respect to the properties and/or quality of the selected workpiece, at least with a certain level of statistical confidence.

According to a further preferred example embodiment of the invention, it is provided that the algorithm selects the particular last workpiece from a production lot. It has been proven, in fact, that the particular last workpiece of a production lot of workpieces is particularly well suited for enabling an inference to be made regarding the quality of the other workpieces of the production lot. Thus, the particular last workpiece of a production lot is therefore representative of the production lot in a particular way. This appears to also be due to the fact that the machine tools involved at the production line slowly drift away, at times, from the preset machining parameters in the course of the machining processes of a production lot, whether due to wear of a utilized tool or simply due to the sustained load. This drifting-away of the machining parameters is usually greatest toward the end of the production lot such that the last workpiece of the production lot generally has the comparatively lowest quality and/or deviates farthest from the target properties. Accordingly, it can be detected on the basis of the last workpiece of the production lot whether the remaining workpieces of the production lot are in order in terms of quality.

Alternatively preferably, the algorithm can also be designed for randomly selecting a workpiece from a production lot.

According to a further preferred example embodiment of the invention, it is provided that the assignment of a link of the data set and/or of the at least one further data set of the workpiece is to the production lot. In this case, the data set or the at least one further data set is therefore assigned not only to the specific workpiece, the data of which were actually acquired, but rather to the entire production lot. This is of great advantage, in particular, for the case in which the selected workpiece is representative of the production lot. Due to the fact that only one single workpiece is considered to be representative of the production lot, a considerably reduced amount of effort results as compared to the acquisition, creation, and assignment of data sets for every single workpiece of the production lot.

According to a further preferred example embodiment of the invention, it is provided that the algorithm also selects the workpiece for the case in which the data set deviates from a predefined standard data set by more than a tolerance range. In this case, this is a NOK part, which either must be discarded or must be at least individually re-worked. Due to the extraction of these NOK parts, the advantage results that no faulty workpieces are conveyed further in the production process and are installed, for example, in comparatively complex assemblies such as, for example, a vehicle transmission, where these would result in a malfunction or a failure of the complex assembly during the operation of the complex assembly. NOK parts are also known as alarm parts. NOK parts or alarm parts are advantageously detected as such parts on the basis of the assigned data set of the NOK parts or alarm parts. The re-working or disposal is preferably preceded by a separate and comparatively complex measurement process, in which it is established whether a re-working is possible and whether it makes sense how the re-working is to be carried out. This comparatively complex measurement process is also a subsequent process, which can be selected in an automated manner.

Preferably, it is provided that the algorithm also selects the workpiece exclusively for the case in which the data set deviates from a predefined standard data set by more than a tolerance range.

The standard data set can include a plurality of detected variables, the target values of which are each indicated in the standard data set. This is, therefore, a multidimensional data set. For each variable, the data set can also include a tolerance value, which specifies a permissible deviation from the particular target value. If a target value of the standard data set is exceeded or fallen below by more than the associated tolerance value, the corresponding workpiece can be detected as a NOK part and extracted.

Preferably, NOK parts of this type are also appropriately labeled as NOK parts. This simplifies a subsequent analysis of the underlying source of faults in the production process and, thus, simplifies the task of finding the source of faults as well as eliminating the source of faults.

According to a further preferred example embodiment of the invention, it is provided that the assignment is utilized as traceability information of the workpiece. This yields the advantage that, when something conspicuous about the workpiece arises, for example, a failure of the workpiece, it is possible to identify those production machines by which the workpiece was subjected to which machining processes even later, i.e., for example, after the installation into a complex assembly. This, in turn, permits additional insights into the effects of production influences upon the subsequent behavior of the workpieces and describes a long-term behavior of the workpieces. This type of information can be advantageously utilized in order to improve the quality of future workpieces, in particular with respect to their long-term behavior, by adapting the production processes.

According to one particularly preferred example embodiment of the invention, it is provided that the subsequent process is an inspection process carried out by an inspection machine, wherein a further data set describing the inspection process is acquired. This yields the advantage that the workpiece is not characterized exclusively on the basis of data of the workpiece describing the machining process, but rather also on the basis of actual inspection data. Inspection data generally describe the properties of the workpiece comparatively more precisely and directly than data describing the machining process.

According to one particularly preferred example embodiment of the invention, it is provided that the workpiece is guided back into the production lot of the workpiece after the inspection process. This yields the advantage that the workpiece is not withdrawn from the further machining processes and, thus, does not reduce the throughput of manufactured parts. In addition, the workpiece can be subjected to further machining operations by further machine tools and the data sets of the workpiece can also be acquired, thereby yielding further possibilities for analysis and relationships between the machining processes.

According to a further preferred example embodiment of the invention, it is provided that the machining operation is adapted for subsequent workpieces on the basis of the further data set describing the inspection process. This yields the advantage that, in particular, the detection of a gradual drifting-away of the machining parameters can be advantageously utilized in order to readjust the machining parameters, in particular without interrupting the machining operation. Therefore, a closed-loop control of the parameters of the machining process is possible on the basis of the properties of the workpiece.

Example aspects of the invention also relate to a system for the automated characterization of a workpiece, including at least one machine tool and/or one inspection machine and/or one database. The system is designed for acquiring, during a machining operation by a machine tool, a data set describing the machining operation. The system is also designed for selecting the workpiece from a plurality of workpieces during the machining operation in accordance with an algorithm and extracting the workpiece from the machine tool. The system is further designed for acquiring, during an inspection process carried out by an inspection machine, a further data set describing the inspection process and for establishing a link of the data set and/or of the further data set to the workpiece via an assignment. The system according to example aspects of the invention is distinguished by the fact that the system is designed for making a selection of a subsequent process from a plurality of possible subsequent processes in an automated manner via the data set and/or the further data set. The system is therefore designed for carrying out the method steps of the method according to example aspects of the invention. It therefore enables the achievement of the advantages already described in conjunction with the method according to example aspects of the invention.

According to one preferred example embodiment of the invention, it is provided that the system is designed for carrying out the method according to example aspects of the invention. This yields the advantages already described in conjunction with the method according to example aspects of the invention.

### BRIEF DESCRIPTION OF THE DRAWINGS

Example aspects of the invention are explained by way of example in the following with reference to embodiments represented in the figures, wherein:

FIG. 1 shows, by way of example, one possible embodiment of a method according to example aspects of the invention for the automated characterization of a workpiece during a machining operation by a machine tool in the form of a flowchart;

FIG. 2 shows, by way of example, one further possible embodiment of a method according to example aspects of the invention for the automated characterization of a workpiece during a machining operation by a machine tool in the form of a flowchart; and

FIG. 3 shows, by way of example and diagrammatically, one possible embodiment of a system according to example aspects of the invention for the automated characterization of a workpiece.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

Identical objects, functional units, and comparable components are marked with the same reference characters in all figures. These objects, functional units, and comparable components are identically designed with regard to their technical features, as long as nothing else results, explicitly or implicitly, from the description.

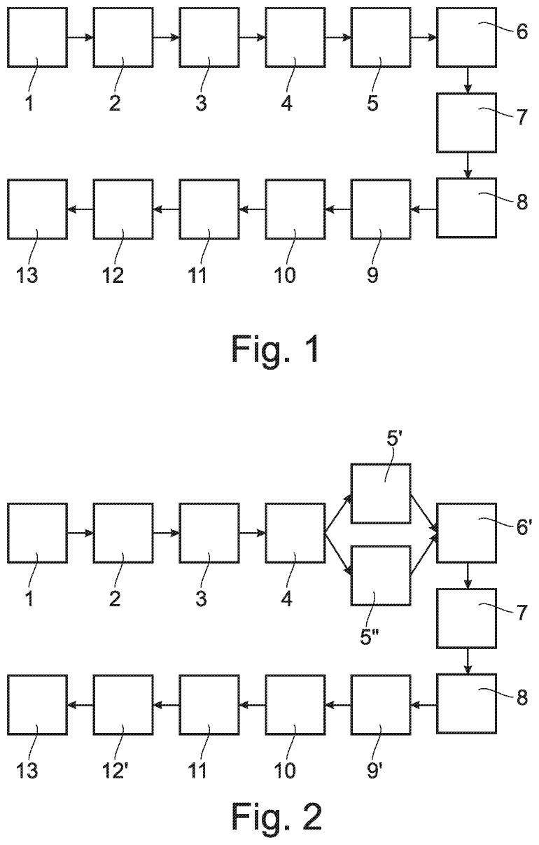

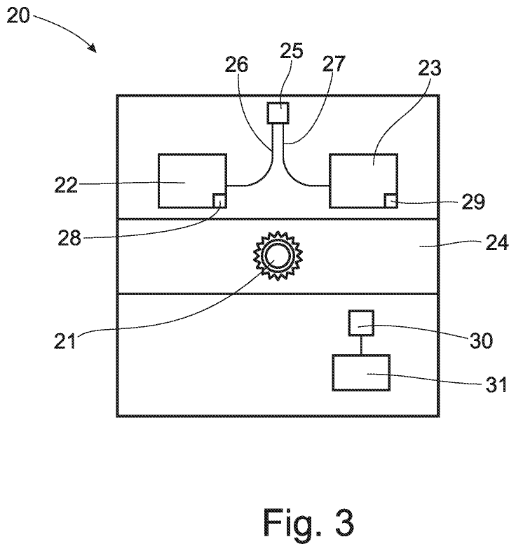

FIG. 1 shows, by way of example, one possible embodiment of a method according to example aspects of the invention for the automated characterization of a workpiece 21 during a machining operation by a machine tool 22, 23 in the form of a flowchart, reference also being made to FIG. 3. In method step 1, the workpiece 21, namely, according to example aspects of the invention, a metallic gearwheel 21 for a vehicle transmission, is subjected to a machining process by the machine tool 22, 23. According to the example, the machine tool 22, 23 is a honing machine. In step 2, the data that describe the machining operation are acquired by the machine tool 22, 23. According to the example, these data are a machining duration and a time-dependent force applied for honing. These data are combined to form a data set, which therefore describes the machining operation by the machine tool 22, 23 on the workpiece 21. In the subsequent method step 3, the workpiece 21 is selected in accordance with an algorithm that represents a statistical selection process for selecting a representative individual from a group. The workpiece 21 is therefore representative of the entire production lot, with which the workpiece 21 was manufactured, and has already been subjected to preceding machining operations. In method step 4, the workpiece 21 is extracted from the machine tool 22, 23. Immediately after the extraction, in method step 5, a link of the data set to the workpiece 21 is established via an assignment. The assignment takes place, according to the example, by arranging the data set directly on the workpiece 21, namely in the form of a data matrix code, which is embossed into the material of the workpiece 21. In the following method step 6, a selection of a subsequent process from a plurality of possible subsequent processes is carried out in an automated manner via the data set. For this purpose, the data matrix code arranged on the workpiece 21 is detected by a camera 30 and the represented data set is evaluated by a processing unit 31 designed for this purpose. Since the data set describes, according to the example, a comparatively great force applied during honing, in step 6, two inspection processes are selected as the subsequent processes, namely a gear inspection and a material hardness inspection. The gear inspection is carried out in step 7 and indicates no unusual deviation from the desired gear tooth shape. The data acquired during the inspection process are acquired in step 8 and combined to form a further data set. In step 9, the further data set is also arranged on the workpiece 21 in the form of a data matrix code and, thus, a link is established between the workpiece 21, the data set describing the machining operation, and the further data set describing the inspection process. In step 10, the material hardness inspection is carried out, which, according to the invention, also does not indicate an unusual deviation from the desired material hardness. In step 11, yet another data set is created, which describes the inspection process of the material hardness inspection. In step 12, this yet another data set is also applied, as a data matrix code, onto the workpiece 21 such that the yet another data set is also linked to the workpiece 21. Simultaneously, a link is also established to the data set describing the machining operation and to the further data set describing the inspection process. Since the workpiece 21 was selected in step 3 as a representative of the entire production lot, an inference to the quality of all other workpieces 21 of the production lot can be made in method step 13 on the basis of the established properties of the workpiece 21, i.e., on the basis of the quality of the workpiece 21. The inspection of every single workpiece 21, which would otherwise be necessary, can therefore be dispensed with.

FIG. 2 shows, by way of example, one further possible embodiment of a method according to the invention for the automated characterization of a workpiece 21 during a machining operation by a machine tool 22, 23 in the form of a flowchart. The method from FIG. 2 largely corresponds to the method from FIG. 1, although the assignment is not carried out via the application of a data matrix code on the workpiece 21 as in step 5 from FIG. 1. Instead, in method step 5′ from FIG. 2, a numerical code is applied on the workpiece in the form of a label. The numerical code represents an individual identification of the workpiece 21 and simultaneously corresponds to a digital address in an electronic database. In the step 5″ taking place simultaneously with step 5′, the acquired data set is transmitted into this electronic database and retrievably stored in the electronic database under the digital address. According to the example, in step 6′, the selection of a subsequent process from a plurality of possible subsequent processes is therefore carried out without reverting to a camera 30, since the data set can be retrieved directly from the database and evaluated by a processing unit 31 designed for this purpose. In a similar way, in step 9′ as well, the further data set, which describes the gear inspection process, is also retrievably stored in the database under the digital address and, in step 12′, the yet another data set, which describes the material hardness inspection process, is retrievably stored in the database under the digital address. The link of the workpiece 21 to the data set, to the further data set, and to the yet another data set is therefore carried out according to the example via the numerical code and/or the digital address.

FIG. 3 shows, by way of example and diagrammatically, one possible design of a system 20 according to the invention for the automated characterization of a workpiece 21. The system includes, according to the example, two machine tools 22 and 23, which represent a production line in the sense that the workpiece 21 is initially fed, via feeding equipment 24, to the machine tool 22, is machined by this machine tool 22, and, thereafter, is fed to the machine tool 23 and is machined by this machine tool 23. The feeding equipment 24 is, according to the example, a conveyor 24. The machine tools 22 and 23 are designed for automatically receiving the workpiece 21 from the feeding equipment 24 and, once the machining operation has been completed, placing the workpiece 21 back on the feeding equipment 24. During the machining operations by the machine tools 22 and 23, a data set describing the particular machining operation is acquired in each case. In accordance with an algorithm, which is executed by an electronic arithmetic unit 25 and is connected to the machine tools 22 and 23 via data lines 26 and 27 at the data level, the workpiece 21 can be selected from a plurality of workpieces 21 during a machining operation by one of the machine tools 22 and 23 in accordance with the algorithm and extracted from the particular machine tool 22 or 23. During the extraction, the machine tools 22 and 23 can output a label with a data matrix code, via a printer 28 and 29 assigned thereto, respectively, and apply the label to the workpiece 21. The data matrix code describes the data set. The attachment of the label on the workpiece 21 represents an assignment that establishes a link of the data set to the workpiece. The system 20 also includes a camera 30 and a processing unit 31, wherein the camera 30 can detect the data matrix code applied on the workpiece and the processing unit 31 can evaluate the data matrix code. The processing unit 31 is also designed for making a selection of a subsequent process from a plurality of possible subsequent processes in an automated manner via the data set.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 machining operation
2 acquisition of the data set
3 selection of the workpiece
4 extraction of the workpiece
5 establishment of the assignment, arrangement of the data matrix code
5′ establishment of the assignment, arrangement of the label
5′″ transmission of the data set to the database
6 determination of the subsequent process
6′ determination of the subsequent process
7 gear inspection
8 acquisition of the further data set
9 establishment of the assignment, arrangement of the data matrix code
9′ transmission of the further data set to the database
10 material hardness inspection
11 acquisition of the yet another data set
12 establishment of the assignment, arrangement of the data matrix code
12′ transmission of the yet another data set to the database
13 inference of the quality of all other workpieces
20 system
21 workpiece, metallic gearwheel
22 machine tool
23 machine tool
24 feeding equipment, conveyor
25 electronic arithmetic unit
26 data line
27 data line
28 printer
29 printer
30 camera
31 processing unit

1-15: (canceled)

16. A method for automated characterization of a workpiece (21) during a machining operation by a machine tool (22, 23, 1), comprising:
acquiring a data set describing the machining operation;
selecting a workpiece (21) from a plurality of workpieces (21) in accordance with an algorithm;
extracting the workpiece (21) from the plurality of workpieces (21);
linking the data set to the workpiece (21) via an assignment; and
selecting a subsequent process from a plurality of possible subsequent processes (6, 6′) in an automated manner via the data set.

17. The method of claim 16, wherein the assignment comprises at least one further link to at least one further data set.

18. The method of claim 17, wherein the assignment comprises arranging (5, 9, 12) one or both of the data set and the at least one further data set directly on the workpiece.

19. The method of claim 18, wherein one or both of the data set and the at least one further data set is arranged (5, 9, 12) on the workpiece as a data matrix code or as a label.

20. The method of claim 17, wherein one or both of the data set and the at least one further data set is stored (9′, 12′) in a database, and the assignment comprises arranging (5′) a piece of information referring to one or both of the data set and the at least one further data set on the workpiece.

21. The method of claim 16, wherein the assignment comprises arranging (5, 9, 12) the data set directly on the workpiece.

22. The method of claim 21, wherein the data set is arranged (5, 9, 12) on the workpiece as a data matrix code or as a label.

23. The method of claim 16, wherein the data set is stored (9′, 12′) in a database, and the assignment comprises arranging (5′) a piece of information referring to the data set on the workpiece.

24. The method of claim 16, wherein the algorithm comprises a statistical method for selecting random samples.

25. The method of claim 16, wherein the algorithm selects a last workpiece from each production lot for the workpiece (21).

26. The method of claim 25, wherein the assignment comprises a link of one or both of the data set and at least one further data set of the workpiece (21) to the production lot.

27. The method of claim 16, wherein the algorithm selects the workpiece (21) for which the data set deviates from a predefined standard data set by more than a tolerance range.

28. The method of claim 16, further comprising utilizing the assignment as traceability information of the workpiece (21).

29. The method of claim 16, wherein the subsequent process comprises an inspection process carried out by an inspection machine, the method further comprising acquitting a further data set describing the inspection process.

30. The method of claim 29, further comprising guiding the workpiece (21) back into a production lot after the inspection process.

31. The method of claim 30, further comprising adapting the machining operation for subsequent workpieces (21) based on the further data set describing the inspection process.

32. A system (20) for the automated characterization of a workpiece (21), comprising:
at least one machine tool (22, 23);
at least one inspection machine; and
a database,
wherein the system (20) is configured for
acquiring, during a machining operation by the machine tool (22, 23), a data set describing the machining operation,
selecting a workpiece (21) from a plurality of workpieces (21) during the machining operation in accordance with an algorithm,
extracting the workpiece (21) from the machine tool (22, 23),
acquiring, during an inspection process carried out by the inspection machine, a further data set describing the inspection process,
establishing a link of one or both of the data set and the further data set to the workpiece (21) via an assignment, and
selecting a subsequent process from a plurality of possible subsequent processes in an automated manner via one or both of the data set and the further data set.

33. A system (20) for the automated characterization of a workpiece (21), wherein the system (20) is configured for implementing the method of claim 16.
